(19) United States
(12) Patent Application Publication
(10) Pub. No.: US 2025/0355585 A1
(43) Pub. Date: Nov. 20, 2025

(54) STORAGE SYSTEM AND VOLUME PATH SWITCHING METHOD FOR STORAGE SYSTEM

(71) Applicant: Hitachi Vantara, Ltd., Yokohama-shi (JP)

(72) Inventors: Keigo KOZAI, Tokyo (JP); Naoyuki MATSUNAGA, Tokyo (JP)

(21) Appl. No.: 19/074,547

(22) Filed: Mar. 10, 2025

(30) Foreign Application Priority Data
May 17, 2024 (JP) 2024-080917

(51) Int. Cl. G06F 3/06

(52) U.S. Cl. CPC G06F 3/0635; G06F 3/0655; G06F 3/067

(57) ABSTRACT

An object is to reduce the load on a network of a storage system in an on-premises environment to which a cloud storage is externally connected. The storage system manages first mapping information for mapping a second volume to a host via a first path and second mapping information for mapping the second volume to the host via a second path that traverses through a second network. The storage system executes path switching from the first path based on the first mapping information to the second path based on the second mapping information when a predetermined condition is satisfied.

### CROSS-REFERENCE TO RELATED APPLICATION

The present application claims priority from Japanese application JP2024-080917, filed on May 17, 2024, the content of which is hereby incorporated by reference into this application.

### BACKGROUND OF THE INVENTION

### 1. Field of the Invention

The present invention relates to a storage system and a volume path switching method for the storage system.

### 2. Description of the Related Art

Hitherto, in a storage system in an on-premises environment, when a load of input/output (IO) from a host to a volume becomes high, path changes are performed among a plurality of paths from the host to the volume to distribute the load. For example, U.S. Pat. No. 9,882,805 discloses a related art that changes, based on load information obtained from network switches configured to connect a host to a volume, a network switch through which IO from the host to the volume passes.

### SUMMARY OF THE INVENTION

In recent years, a cloud storage built in cloud environments has become widespread. When used in combination with storage systems in on-premises environments, a cloud storage may be externally connected to the storage systems in the on-premises environments to avoid complex management. When a cloud storage is externally connected to a storage system in an on-premises environment, all IO to volumes of the cloud storage pass through the storage system in the on-premises environment. Therefore, the load on the network in the on-premises environment increases not only due to IO to the volumes in the on-premises environment themselves, but also due to increased IO related to batch processing or the like to the volumes of the cloud storage via the on-premises environment in busy periods or the like.

However, when the load on the network in the on-premises environment increases, even if the network switch in the on-premises environment is changed as in the above-mentioned related art, the load is only rebalanced within the on-premises environment, and the load on the network in the entire on-premises environment is not reduced, which has been a problem. If the load on the network in the on-premises environment is not reduced, inconveniences, for example, delays in IO to the volumes of the storage system in the on-premises environment, which is real-time processing, occur.

The present invention has been made in view of the above-mentioned problems, and it is an object of the present invention to reduce the load on a network of a storage system in an on-premises environment to which a volume of cloud storage is externally connected.

In order to achieve the above-mentioned object, according to the present invention, there is provided a storage system including a first storage on-premises, a second storage on a cloud, a host, and a server configured to manage the host, the first storage, and the second storage via a second network. The first storage is connected to the host via a first network for input/output from the host and provides a plurality of volumes including a first volume to the host, and the second storage is connected to the host via a first path that traverses through the first network and the first storage for the input/output from the host, and provides a second volume to the host. The server is configured to manage first mapping information for mapping the second volume to the host via the first path and second mapping information for mapping the second volume to the host via a second path that traverses through the second network, and execute path switching from the first path based on the first mapping information to the second path based on the second mapping information when a predetermined condition is satisfied.

According to the present invention, it is possible to reduce the load on the network of the storage system in the on-premises environment to which the volume of the cloud storage is externally connected.

### BRIEF DESCRIPTION OF THE DRAWINGS

FIG. 1 is a diagram illustrating a configuration of a storage system according to an embodiment;

FIG. 2 is a diagram illustrating a configuration of a path migration threshold table according to the embodiment;

FIG. 3 is a diagram illustrating a configuration of a volume management table according to the embodiment;

FIG. 4 is a diagram illustrating a configuration of an access volume management table according to the embodiment;

FIG. 5 is a sequence diagram illustrating path switching processing according to the embodiment;

FIG. 6 is a flowchart illustrating threshold setting unit processing according to the embodiment;

FIG. 7 is a sequence diagram illustrating volume configuration monitoring unit processing and access volume information update unit processing according to the embodiment;

FIG. 8 is a flowchart illustrating path load monitoring unit processing according to the embodiment;

FIG. 9 is a sequence diagram illustrating path switching volume selection unit processing and cloud service usage fee calculation unit processing according to the embodiment;

FIG. 10 is a sequence diagram illustrating path switching unit processing according to the embodiment; and

FIG. 11 is a sequence diagram illustrating path restoration unit processing according to the embodiment.

### DESCRIPTION OF THE PREFERRED EMBODIMENT

In the following description, “interface device” may refer to one or more communication interface devices. The one or more communication interface devices may be one or more communication interface devices of the same type (for example, one or more network interface cards (NICs)) or two or more communication interface devices of different types (for example, a NIC and a host bus adapter (HBA)).

Further, in the following description, “memory” may refer to one or more memory devices, which are examples of one or more storage devices, and may typically be main storage devices. At least one memory device in the memory may be a volatile memory device or a non-volatile memory device.

Further, in the following description, “storage device” refers to examples of one or more persistent storage devices. The persistent storage device may typically be a non-volatile storage device (for example, an auxiliary storage device) and may specifically be, for example, a hard disk drive (HDD), a solid-state drive (SSD), or a non-volatile memory express (NVMe) drive.

Further, in the following description, “processor” may refer to one or more processor devices. At least one processor device may typically be a microprocessor device such as a central processing unit (CPU), but may be other types of processor devices such as a graphics processing unit (GPU). At least one processor device may be a single-core or multi-core processor device. At least one processor device may be a processor core. At least one processor device may be a processor device in a broad sense such as a hardware circuit (for example, a field-programmable gate array (FPGA), a complex programmable logic device (CPLD), or an application-specific integrated circuit (ASIC)) configured to perform part or all of the processing.

Further, in the following description, information for obtaining output for input may be described with such expressions as “xxx table.” This information may be data of any structure (for example, structured data or unstructured data). Therefore, “xxx table” can be called “xxx information.” Further, in the following description, configurations of respective tables are examples. One table may be divided into two or more tables, and all or part of two or more tables may be one table.

Further, in the following description, “program” is used as a subject to describe processing in some cases. A program performs, when executed by a processor, defined processing while appropriately using storage devices and/or interface devices, for example. Therefore, the subject of the processing may be the processor (or such a device as a controller including that processor). The program may be installed on such a device as a computer from a program source. The program source may be, for example, a program distribution server or a computer-readable (for example, non-transitory) recording medium. Furthermore, in the following description, two or more programs may be achieved as one program, or one program may be achieved as two or more programs.

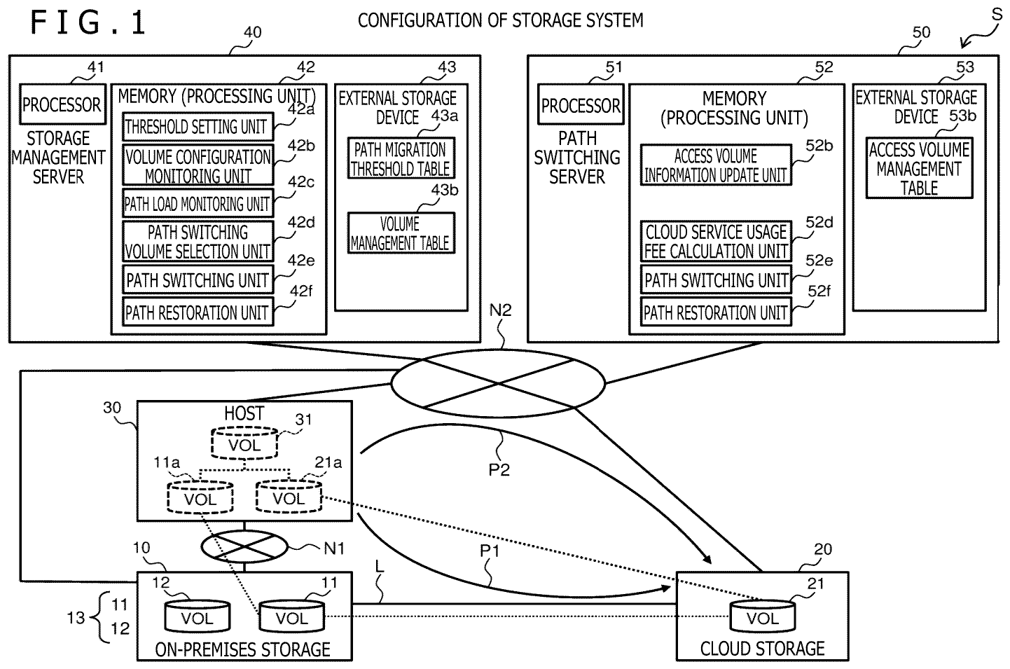

Now, an embodiment of the present invention is described using FIG. 1 to FIG. 11.

### Configuration of Storage System S According to Embodiment

FIG. 1 is a diagram illustrating a configuration of a storage system S according to the embodiment. The storage system S includes an on-premises storage 10, a cloud storage 20, a host 30, a storage management server 40, and a path switching server 50.

The on-premises storage 10, the cloud storage 20, the host 30, the storage management server 40, and the path switching server 50 are connected to one another via a network N2. The network N2 is an Internet Protocol (IP) network but is not limited to this.

The on-premises storage 10 is a storage built in an on-premises environment. The on-premises storage 10 includes a processor, a memory, and a storage device (all not shown). The on-premises storage 10 includes a volume 11 and a volume 12. The volume 11 and the volume 12 are collectively referred to as a volume 13.

The volume 12 is a logical storage area cut out from a pool volume (not shown) that is a logical storage area created from a physical storage area of the storage device (not shown) of the on-premises storage 10, and is provided to the host 30.

The volume 11 is a volume for making the host 30 recognize a cloud volume 21 of the cloud storage 20, which is externally connected as an external connection storage via a predetermined port and a communication line L, via the on-premises storage 10 and the communication line L.

The cloud storage 20 is a storage built in a public or private cloud environment. The cloud storage 20 includes a processor, a memory, and a storage device (all not shown). The cloud storage 20 includes the cloud volume 21. The cloud volume 21 is a logical storage area created from a physical storage area of the storage device (not shown) of the cloud storage 20. The cloud volume 21 is integrally managed with the volume 11, as an external connection volume for the volume 11.

The host 30 includes a processor and a memory (both not shown). The host 30 is connected to the on-premises storage 10 via a network N1. The network N1 is assumed to be a small computer system interface (SCSI) network but is not limited to this and can adopt various protocols.

The cloud volume 21 of the cloud storage 20 is mapped to the host 30 via the network N1 and the volume 11 with a via-SCSI virtual volume 11a as mapping information. Further, the cloud volume 21 is mapped to the host 30 via the network N2 with a via-IP virtual volume 21a as mapping information.

Further, the host 30 makes an application recognize the via-SCSI virtual volume 11a and the via-IP virtual volume 21a as an application volume 31 which is a single virtual volume. The application volume 31 is a virtual volume for each application that is executed on the host 30 and issues IO requests.

The host 30 issues IO requests to the volume 11 of the on-premises storage 10 and the cloud volume 21 of the cloud storage 20. Data related to IO requests from the host 30 to the cloud volume 21 is read and written via a path P1 that traverses through the on-premises storage 10 and the communication line L or via a path P2 that traverses through the network N2.

FIG. 1 illustrates one on-premises storage 10, one volume 11, one volume 12, one cloud storage 20, one cloud volume 21, one host 30, one application volume 31, one via-SCSI virtual volume 11a, and one via-IP virtual volume 21a. However, the present invention is not limited to this, and there may be a plurality of each of the above elements.

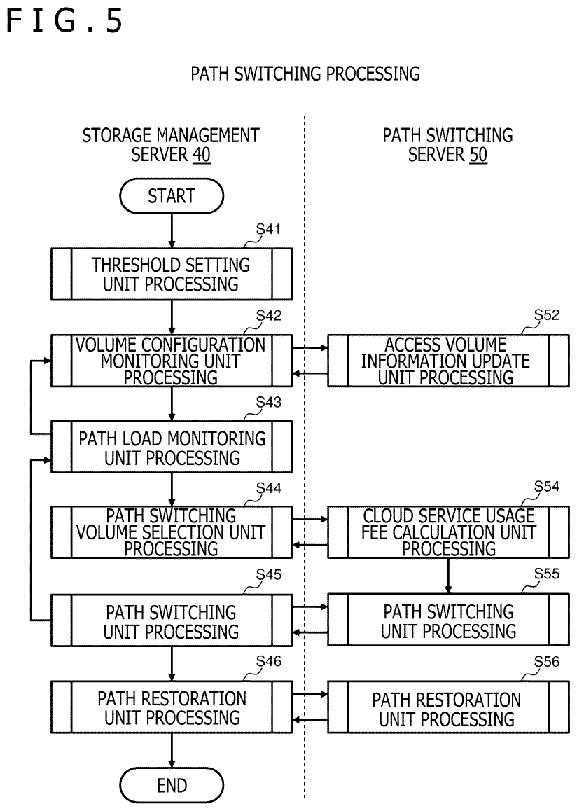

The storage management server 40 includes a processor 41, a memory 42, and an external storage device 43. The processor 41 achieves various processing units stored in the memory 42, by executing predetermined programs. The memory 42 includes a threshold setting unit 42a, a volume configuration monitoring unit 42b, a path load monitoring unit 42c, a path switching volume selection unit 42d, a path switching unit 42e, and a path restoration unit 42f. Processing functions of the threshold setting unit 42a, the volume configuration monitoring unit 42b, the path load monitoring unit 42c, the path switching volume selection unit 42d, the path switching unit 42e, and the path restoration unit 42f are described later with reference to FIG. 5 to FIG. 11.

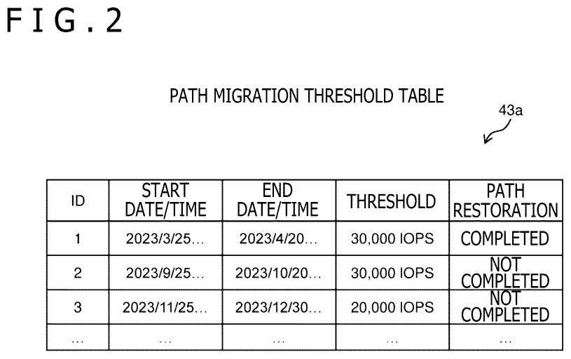

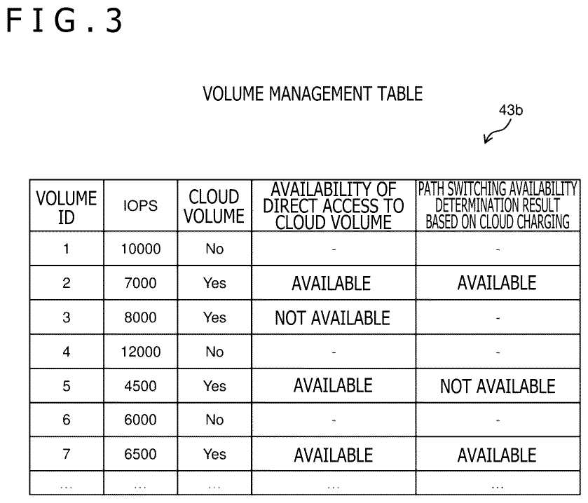

The external storage device 43 has a path migration threshold table 43a and a volume management table 43b. Details of the path migration threshold table 43a and the volume management table 43b are described later with reference to FIG. 2 and FIG. 3.

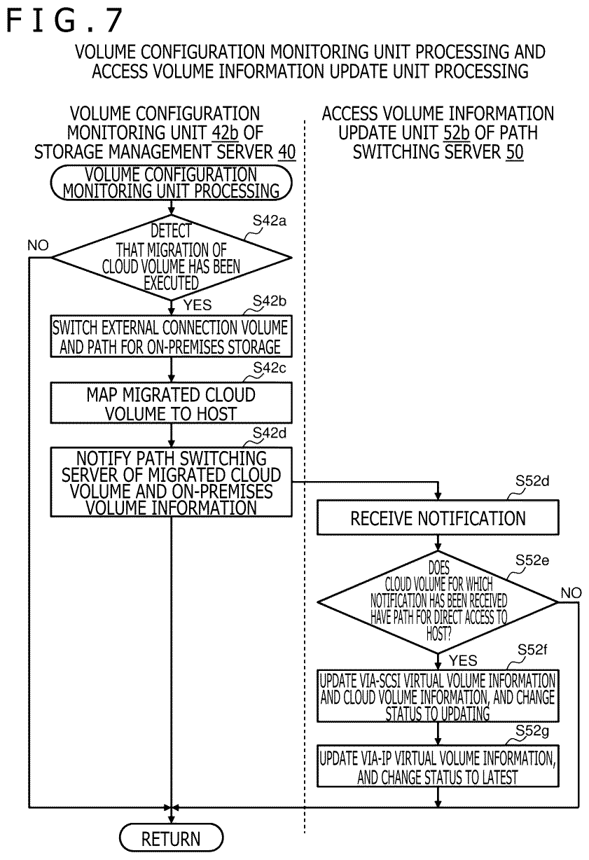

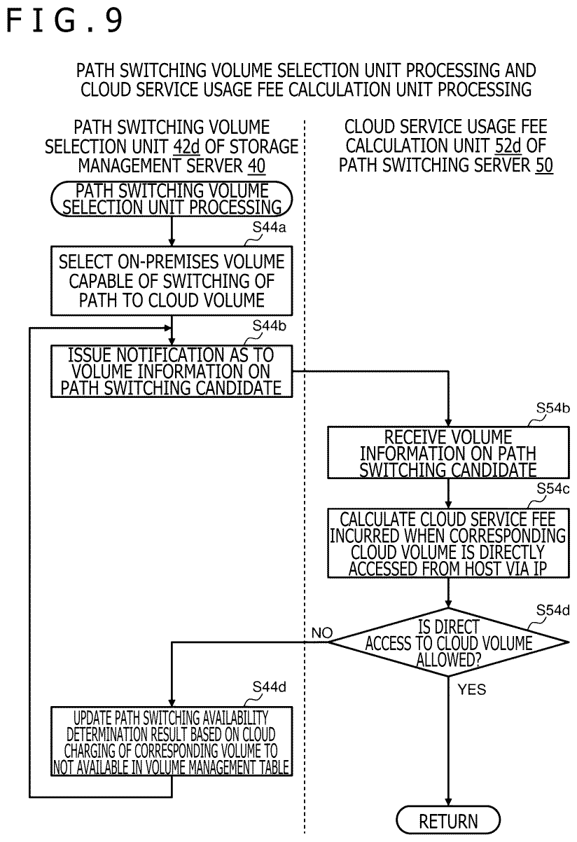

The path switching server 50 includes a processor 51, a memory 52, and an external storage device 53. The processor 51 achieves various processing units stored in the memory 52, by executing predetermined programs. The memory 52 includes an access volume information update unit 52b, a cloud service usage fee calculation unit 52d, a path switching unit 52e, and a path restoration unit 52f. Processing functions of the access volume information update unit 52b, the cloud service usage fee calculation unit 52d, the path switching unit 52e, and the path restoration unit 52f are described later with reference to FIG. 5, FIG. 7, and FIG. 9 to FIG. 11.

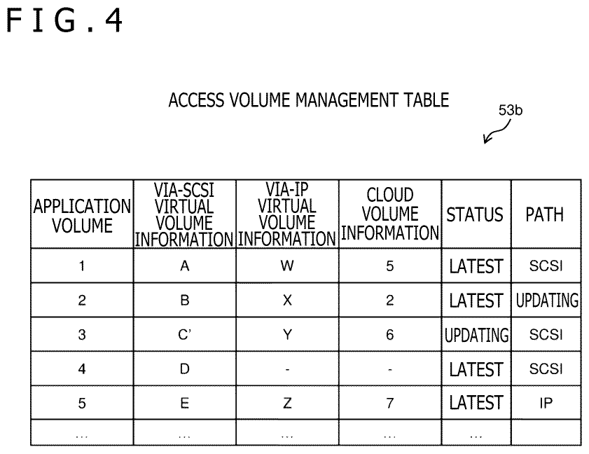

The external storage device 53 has an access volume management table 53b. Details of the access volume management table 53b are described later with reference to FIG. 4.

### Path Migration Threshold Table 43a According to Embodiment

FIG. 2 is a diagram illustrating a configuration of the path migration threshold table 43a according to the embodiment. The path migration threshold table 43a manages thresholds and periods for executing path migration that are set in advance by a user. The path migration threshold table 43a has columns of “ID,” “START DATE/TIME,” “END DATE/TIME,” “THRESHOLD,” and “PATH RESTORATION.”

“ID” is identification information on “THRESHOLD.” “START DATE/TIME” is the start date/time of a path switching implementation period based on an IO load determination with the corresponding “THRESHOLD.” “END DATE/TIME” is the end date/time of the path switching implementation period based on a load determination with the corresponding “THRESHOLD.” “Path switching implementation period based on the load determination” refers, for example, to an accounting period in which batch processing intensively occurs.

“THRESHOLD” is a threshold for a load of IO from the host 30 to the on-premises storage 10, which serves as a determination criterion for switching the path from the host 30 to the cloud volume 21. In the present embodiment, the IO load is input/output per second (IOPS), but other load indicators may be used. When the load of IO from the host 30 to the on-premises storage 10 exceeds “THRESHOLD,” the path from the host 30 to the cloud volume 21 is switched for any of the cloud volumes 21 capable of executing path switching. That is, path switching is executed from the path P1 that traverses through the on-premises storage 10 and the communication line L to the path P2 that traverses through the network N2.

“PATH RESTORATION” indicates whether, after path switching (path P1-path P2) for the corresponding cloud volume 21 has been performed, path restoration (path P2-path P1) for restoring the path used before the path switching has been executed or not.

### Volume Management Table 43b According to Embodiment

FIG. 3 is a diagram illustrating a configuration of the volume management table 43b according to the embodiment. The volume management table 43b manages information concerning IO performance of the volume 13 of the on-premises storage 10 and concerning the cloud volume 21. The volume management table 43b has columns of “VOLUME ID,” “IOPS,” “CLOUD VOLUME,” “AVAILABILITY OF DIRECT ACCESS TO CLOUD VOLUME,” and “PATH SWITCHING AVAILABILITY DETERMINATION RESULT BASED ON CLOUD CHARGING.”

“VOLUME ID” is identification information on the volume 13 of the on-premises storage 10. “IOPS” is the IO load for the corresponding volume 13. “IOPS” is measured and updated periodically for each volume.

“CLOUD VOLUME” is information on whether the cloud volume 21 is externally connected to the corresponding volume 13. “The cloud volume 21 is externally connected to the corresponding volume 13” corresponds to a case where the volume 13 is the volume 11. “YES” is set in “CLOUD VOLUME” when the cloud volume 21 is externally connected to the volume 13.

“AVAILABILITY OF DIRECT ACCESS TO CLOUD VOLUME” is information on whether the host 30 can directly access the cloud volume 21 via the IP or not when the cloud volume 21 is externally connected to the corresponding volume 13. “AVAILABLE” or “NOT AVAILABLE” is set by the user in “AVAILABILITY OF DIRECT ACCESS TO CLOUD VOLUME” when the cloud volume 21 is externally connected to the volume 13.

“PATH SWITCHING AVAILABILITY DETERMINATION RESULT BASED ON CLOUD CHARGING” is the determination result of determining the availability of path switching based on cloud charging when “AVAILABILITY OF DIRECT ACCESS TO CLOUD VOLUME” is “AVAILABLE” (the host 30 can directly access the cloud volume 21). The determination result of path switching availability is set to “AVAILABLE” when the usage fee of the cloud storage 20, which is charged by path switching from the path P1 to the path P2 (see FIG. 1), is within an acceptable range of the user, and to “NOT AVAILABLE” when the usage fee is outside the acceptable range. Path switching is executed when “PATH SWITCHING AVAILABILITY DETERMINATION RESULT BASED ON CLOUD CHARGING” is “AVAILABLE,” and path switching is not executed when it is “NOT AVAILABLE.” “AVAILABLE” is stored as an initial value at the time of entry generation in “PATH SWITCHING AVAILABILITY DETERMINATION RESULT BASED ON CLOUD CHARGING.”

### Access Volume Management Table 53b According to Embodiment

FIG. 4 is a diagram illustrating a configuration of the access volume management table 53b according to the embodiment. The access volume management table 53b manages volume information and paths linked to the application volume 31 to be accessed by applications on the host 30 side. The access volume management table 53b has columns of “APPLICATION VOLUME,” “VIA-SCSI VIRTUAL VOLUME INFORMATION,” “VIA-IP VIRTUAL VOLUME INFORMATION,” “CLOUD VOLUME INFORMATION,” “STATUS,” and “PATH.”

“APPLICATION VOLUME” is identification information on the application volume 31 to be accessed by applications which are executed by the host 30.

“VIA-SCSI VIRTUAL VOLUME INFORMATION” is identification information on the via-SCSI virtual volume 11a when the cloud volume 21 linked to the corresponding application volume 31 is accessed via the SCSI (via the on-premises storage 10). “VIA-SCSI VIRTUAL VOLUME INFORMATION” is generated as mapping information to the host 30 via the SCSI when the cloud volume 21 is first externally connected to the volume 11. Further, when the cloud volume 21 undergoes configuration changes, “VIA-SCSI VIRTUAL VOLUME INFORMATION” is updated depending on the configuration changes.

“VIA-IP VIRTUAL VOLUME INFORMATION” is identification information on the via-IP virtual volume 21a when the cloud volume 21 linked to the corresponding application volume 31 is accessed via the IP (via the network N2). “VIA-IP VIRTUAL VOLUME INFORMATION” is generated as mapping information to the host 30 via the IP when the cloud volume 21 is first externally connected to the volume 11. Further, when the cloud volume 21 undergoes such configuration changes as migration, “VIA-IP VIRTUAL VOLUME INFORMATION” is updated depending on the configuration changes.

In the present embodiment, the configuration change of the cloud volume 21 is assumed to be migration, but it may also be a location change for changing the connection destination to a cloud volume at another location.

“CLOUD VOLUME INFORMATION” is identification information on the cloud volume 21 linked to the corresponding application volume 31. “STATUS” indicates whether information on the cloud volume 21 linked to the corresponding application volume 31 is “LATEST” or “UPDATING.” “PATH” indicates whether the path for access to the cloud volume 21 linked to the corresponding application volume 31 traverses through “SCSI” (the network N1 and the on-premises storage 10) or “IP” (the network N2).

### Path Switching Processing According to Embodiment

FIG. 5 is a sequence diagram illustrating path switching processing according to the embodiment. The path switching processing is executed in cooperation between the storage management server 40 and the path switching server 50.

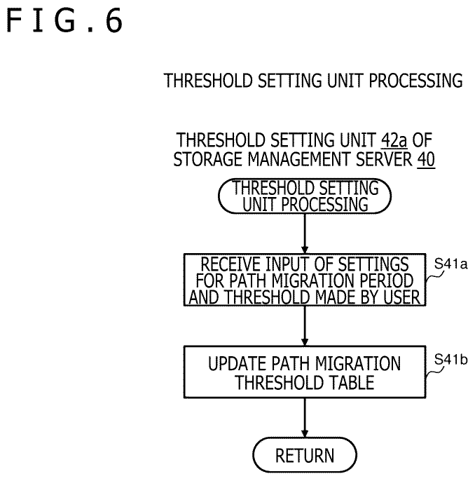

First, in Step S41, the threshold setting unit 42a of the storage management server 40 executes threshold setting unit processing. Details of the threshold setting unit processing are described later with reference to FIG. 6.

Next, in Step S42 and Step S52, the volume configuration monitoring unit 42b of the storage management server 40 and the access volume information update unit 52b of the path switching server 50 cooperate to execute volume configuration monitoring unit processing and access volume information update unit processing. Details of the volume configuration monitoring unit processing and the access volume information update unit processing are described later with reference to FIG. 7.

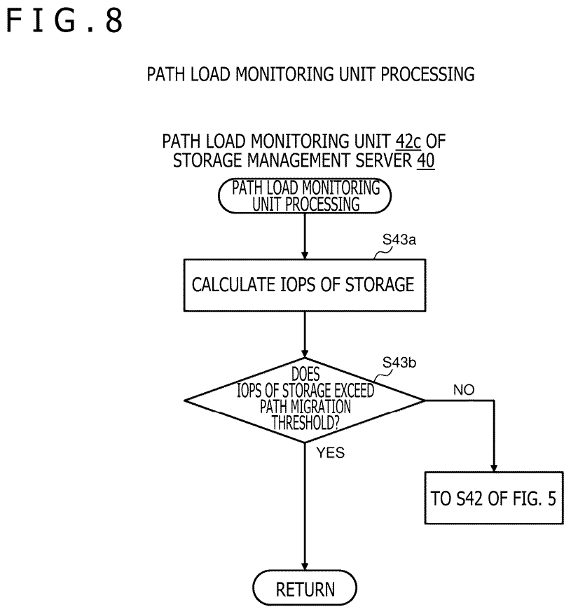

Next, in Step S43, the path load monitoring unit 42c of the storage management server 40 executes path load monitoring unit processing. Details of the path load monitoring unit processing are described later with reference to FIG. 8.

Next, in Step S44 and Step S54, the path switching volume selection unit 42d of the storage management server 40 and the cloud service usage fee calculation unit 52d of the path switching server 50 cooperate to execute path switching volume selection unit processing and cloud service usage fee calculation unit processing. Details of the path switching volume selection unit processing and the cloud service usage fee calculation unit processing are described later with reference to FIG. 9.

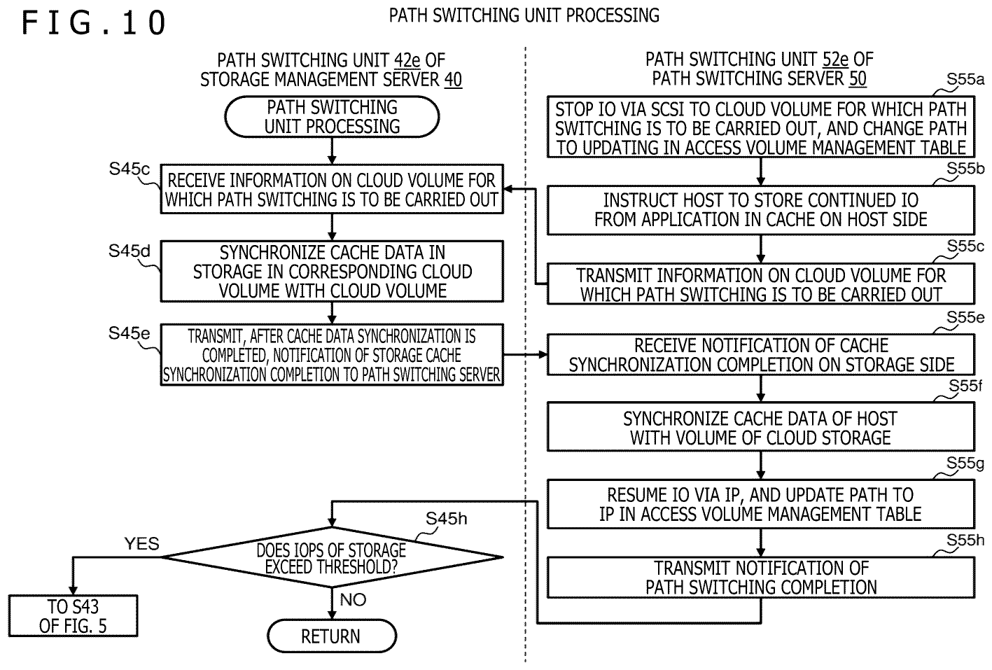

Next, in Step S45 and Step S55, the path switching unit 42e of the storage management server 40 and the path switching unit 52e of the path switching server 50 cooperate to execute path switching unit processing. Details of the path switching unit processing are described later with reference to FIG. 10.

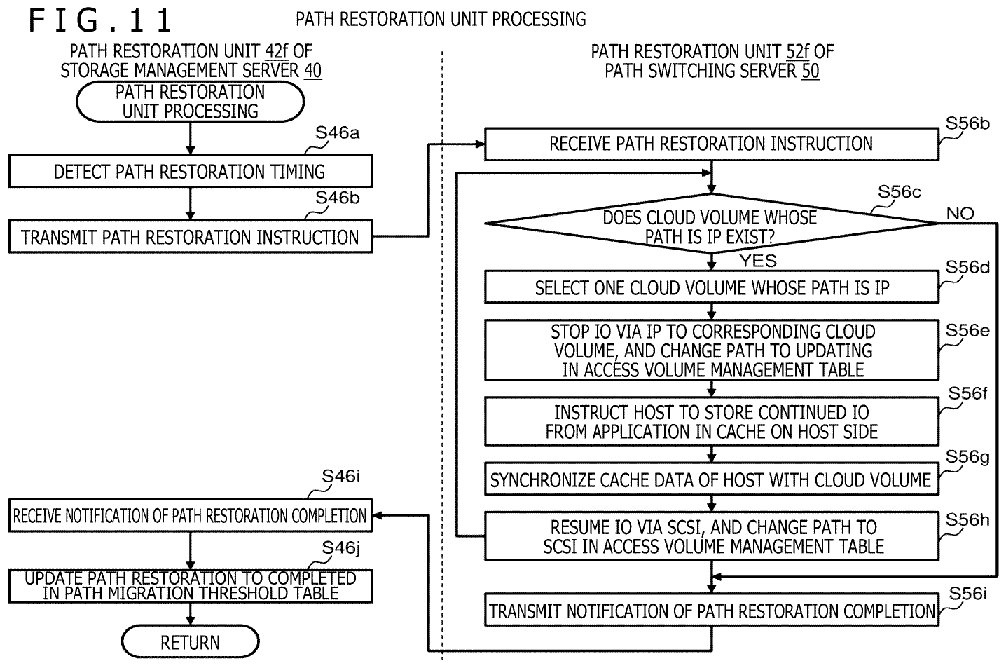

Next, in Step S46 and Step S56, the path restoration unit 42f of the storage management server 40 and the path restoration unit 52f of the path switching server 50 cooperate to execute path restoration unit processing. Details of the path restoration unit processing are described later with reference to FIG. 11.

### Threshold Setting Unit Processing According to Embodiment

FIG. 6 is a flowchart illustrating the threshold setting unit processing according to the embodiment.

First, in Step S41a, the threshold setting unit 42a receives input of settings (or changes) for the path migration period and the threshold made by the user operating a predetermined input-output screen (not shown). Next, in Step S41b, the threshold setting unit 42a updates the path migration threshold table 43a based on the input in Step S41a.

### Volume Configuration Monitoring Unit Processing and Access Volume Information Update Unit Processing According to Embodiment

FIG. 7 is a sequence diagram illustrating the volume configuration monitoring unit processing and the access volume information update unit processing according to the embodiment. The volume configuration monitoring unit processing and the access volume information update unit processing are processing processes for managing, when the cloud volume 21 undergoes configuration changes, configuration information related to the path to enable adaptation to the configuration changes in path switching. In FIG. 7, Step S42a to Step S42d indicate the details of Step S42 of FIG. 5, and Step S52d to Step S52g indicate the details of Step S52 of FIG. 5.

First, in Step S42a, the volume configuration monitoring unit 42b of the storage management server 40 determines whether it has been detected that migration of the cloud volume 21 has been executed in the cloud storage 20. Migration of the cloud volume 21 is either instructed by an operator or instructed by cloud infrastructure (not shown) of the cloud storage 20 with fulfillment of migration execution conditions as a trigger. The volume configuration monitoring unit 42b advances the processing to Step S42b when it has been detected that migration of the cloud volume 21 has been executed (YES in Step S42a). On the other hand, the volume configuration monitoring unit 42b repeats Step S42a when it has not been detected that migration of the cloud volume 21 has been executed (NO in Step S42a).

In Step S42b, in response to the detection of execution of migration of the cloud volume 21, the volume configuration monitoring unit 42b switches the connection relation between the migrated cloud volume 21 and the volume 11 of the on-premises storage 10. Specifically, for example, when “CLOUD VOLUME INFORMATION” on the cloud volume 21 is changed from “5” to “5′” due to the migration, the volume configuration monitoring unit 42b changes “VIA-SCSI VIRTUAL VOLUME INFORMATION” related to the volume 11 on the on-premises storage 10 side.

Next, in Step S42c, the volume configuration monitoring unit 42b maps the migrated cloud volume 21 to the host 30 via the network N2. Then, the volume configuration monitoring unit 42b acquires “VIA-IP VIRTUAL VOLUME INFORMATION” related to the via-IP virtual volume 21a on the host 30 side as mapping information.

Next, in Step S42d, the volume configuration monitoring unit 42b notifies the path switching server 50 of the following information. That is, the volume configuration monitoring unit 42b issues a notification as to the implementation of migration of the cloud volume 21 as well as “CLOUD VOLUME INFORMATION,” “VIA-SCSI VIRTUAL VOLUME INFORMATION,” and “VIA-IP VIRTUAL VOLUME INFORMATION” obtained after the migration.

Next, in Step S52d, the access volume information update unit 52b of the path switching server 50 receives the notification transmitted from the storage management server 40 in Step S42d.

In Step S52e, the access volume information update unit 52b refers to the access volume management table 53b and determines whether the cloud volume 21 for which the notification has been received in Step S52d has a path for direct access to the host 30. “Having a path for direct access” means that a value is stored as “VIA-IP VIRTUAL VOLUME INFORMATION” corresponding to the cloud volume 21 for which the notification has been received in Step S52d in the access volume management table 53b.

The access volume information update unit 52b advances the processing to Step S52f when the cloud volume 21 has a path for direct access to the host 30 (YES in Step S52e). On the other hand, the access volume information update unit 52b ends the volume configuration monitoring unit processing and the access volume information update unit processing when the cloud volume 21 does not have a path for direct access (NO in Step S52e).

In Step S52f, the access volume information update unit 52b updates the via-SCSI virtual volume information and the cloud volume information in the access volume management table 53b with the information received in Step S52d and sets the status to updating. Next, in Step S52g, the access volume information update unit 52b updates the via-IP virtual volume information in the access volume management table 53b with the information received in Step S52d and sets the status to latest.

### Path Load Monitoring Unit Processing According to Embodiment

FIG. 8 is a flowchart illustrating the path load monitoring unit processing according to the embodiment. The path load monitoring unit processing monitors whether a path change for path load reduction is necessary.

First, in Step S43a, the path load monitoring unit 42c of the storage management server 40 refers to the volume management table 43b, acquires the IOPS of all the volumes 13 of the on-premises storage 10, and calculates the total. The total of the IOPS is the IOPS of the on-premises storage 10. Next, in Step S43b, the path load monitoring unit 42c determines whether the IOPS of the on-premises storage 10 calculated in Step S43a exceeds “PATH MIGRATION THRESHOLD.” The path load monitoring unit 42c ends the path load monitoring unit processing and advances the processing to Step S44 of FIG. 5 when the IOPS of the on-premises storage 10 exceeds “PATH MIGRATION THRESHOLD” (YES in Step S43b). On the other hand, the path load monitoring unit 42c returns the processing to Step S42 of FIG. 5 when the IOPS of the on-premises storage 10 does not exceed “PATH MIGRATION THRESHOLD” (NO in Step S43b).

### (Path Switching Volume Selection Unit Processing and Cloud Service Usage Fee Calculation Unit Processing)

FIG. 9 is a sequence diagram illustrating the path switching volume selection unit processing and the cloud service usage fee calculation unit processing according to the embodiment. The path switching volume selection unit processing and the cloud service usage fee calculation unit processing are processing processes for selecting the cloud volume whose path is to switch when path switching is necessary, such as when the IOPS exceeds “PATH MIGRATION THRESHOLD.” In FIG. 9, Step S44a to Step S42d indicate the details of Step S44 of FIG. 5, and Step S54b to Step S54d indicate the details of Step S54 of FIG. 5.

First, in Step S44a, the path switching volume selection unit 42d of the storage management server 40 refers to the volume management table 43b and selects candidate volumes 13 capable of switching of the path to the cloud volume 21. Specifically, the path switching volume selection unit 42d selects the volumes 13 with “YES” as “CLOUD VOLUME” (switchable to the cloud volume 21) from among the volumes 13 of the on-premises storage 10.

Next, in Step S44b, the path switching volume selection unit 42d selects, from the candidates selected in Step S44a, one volume 13 that has the maximum IO load and has “AVAILABLE” as “AVAILABILITY OF DIRECT ACCESS TO CLOUD VOLUME” and “PATH SWITCHING AVAILABILITY DETERMINATION RESULT BASED ON CLOUD CHARGING.” Then, the path switching volume selection unit 42d notifies the path switching server 50 of volume information related to the selected volume 13 as volume information on a path switching candidate.

Next, in Step S54b, the cloud service usage fee calculation unit 52d of the path switching server 50 receives the volume information on the path switching candidate transmitted from the storage management server 40 in Step S44b. Next, in Step S54c, the cloud service usage fee calculation unit 52d calculates a cloud service usage fee incurred when the cloud volume 21 related to the volume information received in Step S54b is directly accessed from the host 30 via the IP. The cloud service usage fee calculation unit 52d calculates the cloud service usage fee from a price list or the like based on the capacity of the cloud volume 21, the amount and speed of communication via the network N2, and the like.

Next, in Step S54d, the cloud service usage fee calculation unit 52d determines whether direct access to the cloud volume at the cloud service fee calculated in Step S54c has been allowed by the user. The cloud service usage fee calculation unit 52d receives input as to whether to allow or disallow the direct access by the user operating a predetermined input-output screen (not shown). The cloud service usage fee calculation unit 52d advances the processing to Step S55 of the path switching processing (FIG. 5) when the direct access to the cloud volume has been allowed by the user (YES in Step S54d). On the other hand, the cloud service usage fee calculation unit 52d advances the processing to Step S44d (FIG. 9) of the path switching processing (FIG. 5) when the direct access to the cloud volume has not been allowed (NO in Step S54d).

In Step S44d, the path switching volume selection unit 42d updates “PATH SWITCHING AVAILABILITY DETERMINATION RESULT BASED ON CLOUD CHARGING” to “NOT AVAILABLE” in the volume management table 43b for the volume for which it has been determined in Step S54d that the direct access is not allowed. When Step S44d ends, the path switching volume selection unit 42d returns the processing to Step S44b.

### Path Switching Unit Processing According to Embodiment

FIG. 10 is a sequence diagram illustrating the path switching unit processing according to the embodiment. The path switching unit processing is processing for switching the path from the host 30 to the cloud volume 21 from via the SCSI (via the network N1 and the on-premises storage 10) to via the IP (via the network N2). In FIG. 10, Step S45c to Step S45h indicate the details of Step S45 of FIG. 5, and Step S55a to Step S55h indicate the details of Step S55 of FIG. 5.

First, in Step S55a, the path switching unit 52e of the path switching server 50 stops the IO via the SCSI to the cloud volume 21 for which path switching is to be performed, and sets “UPDATING” as “PATH” in the access volume management table 53b.

Next, in Step S55b, the path switching unit 52e instructs the host 30 to store the continued IO from the application of the host 30 in a cache on the host 30 side. Next, in Step S55c, the path switching unit 52e notifies the storage management server 40 of “CLOUD VOLUME INFORMATION” on the cloud volume 21 for which path switching is to be carried out.

Next, in Step S45c, the path switching unit 42e of the storage management server 40 receives the cloud volume information on the cloud volume 21, for which path switching is to be carried out, transmitted by the path switching server 50 in Step S55c. Next, in Step S45d, the path switching unit 42e synchronizes cache data in the on-premises storage 10 related to the cloud volume 21 whose cloud volume information has been received in Step S45c with the cloud volume 21.

Next, in Step S45e, the path switching unit 42e notifies, after the synchronization of cache data in Step S45d is completed, the path switching server 50 of the completion of cache data synchronization.

Next, in Step S55e, the path switching unit 52e of the path switching server 50 receives the notification of the completion of cache data synchronization from the storage management server 40. Next, in Step S55f, the path switching unit 52e synchronizes the cache data of the host 30 with the cloud volume 21. Next, in Step S55g, the path switching unit 52e resumes the IO from the host 30 via the network N2 (via the IP) and updates “PATH” of the corresponding volume to “IP” in the access volume management table 53b. With Step S55g, the path switching from the path P1 for access to the cloud volume 21 via the on-premises storage 10 (via the SCSI) to the path P2 for direct access to the cloud volume 21 via the network N2 is completed.

Next, in Step S55h, the path switching unit 52e notifies the storage management server 40 that the path switching has been completed.

Next, in Step S45h, the path switching unit 42e of the storage management server 40 executes the following processing when receiving the notification of the completion of the path switching from the path switching server 50. That is, the path switching unit 42e refers to the volume management table 43b and determines whether there exists in the on-premises storage 10 the volume 13 whose IOPS exceeds “THRESHOLD” in the path migration threshold table. The path switching unit 42e advances the processing to Step S43 of the path switching processing (FIG. 5) when there exists the volume 13 whose IOPS exceeds “THRESHOLD” in the path migration threshold table, and advances the processing to Step S46 of the path switching processing (FIG. 5) when there is no such volume.

### Path Restoration Unit Processing According to Embodiment

FIG. 11 is a sequence diagram illustrating the path restoration unit processing according to the embodiment. The path restoration unit processing is processing for restoring the path for access from the host 30 to the cloud volume 21 from the path P2, which traverses through the IP, to the path P1, which traverses through the SCSI (through the on-premises storage 10) after the end of a busy period set in the path migration threshold table 43a. In FIG. 11, Step S46a to Step S46j indicate the details of Step S46 of FIG. 5, and Step S56b to Step S56i indicate the details of Step S56 of FIG. 5.

First, in Step S46a, the path restoration unit 42f of the storage management server 40 detects a path restoration timing from the current time and the path migration threshold table 43a. Next, in Step S46b, the path restoration unit 42f specifies the cloud volumes 21 corresponding to the restoration timing detected in Step S46a and issues a notification to the path switching server 50 to instruct restoration from the path P2 to the path P1.

Next, in Step S56b, the path restoration unit 52f of the path switching server 50 receives the instruction to perform restoration from the path P2 to the path P1 for the specified cloud volumes 21.

Next, in Step S56c, the path restoration unit 52f determines whether there exist the cloud volumes 21 whose “PATH” is “IP” in the access volume management table 53b, among the cloud volumes 21 included in the instruction received in Step S56b. The path restoration unit 52f advances the processing to Step S56d when there exist the cloud volumes 21 whose “PATH” is “IP” in the access volume management table 53b (YES in Step S56c). On the other hand, the path restoration unit 52f advances the processing to Step S56i when there is no such cloud volume 21 (NO in Step S56c).

In Step S56d, the path restoration unit 52f selects one cloud volume 21 determined to have “IP” as “PATH” in the access volume management table 53b in Step S56c. Next, in Step S56e, the path restoration unit 52f stops the IO via the IP to the cloud volume 21 selected in Step S56d and changes “PATH” to “UPDATING” in the access volume management table 53b.

Next, in Step S56f, the path restoration unit 52f instructs the host 30 to store the continued IO from the application of the host 30 in the cache on the host 30 side. Next, in Step S56g, the path restoration unit 52f synchronizes the cache data of the host 30 included in the instruction in Step S56f with the corresponding cloud volume 21. Next, in Step S56h, the path restoration unit 52f resumes the IO via the SCSI to the corresponding cloud volume 21 and changes “PATH” to “SCSI” in the access volume management table 53b. When Step S56h ends, the path restoration unit 52f returns the processing to Step S56c.

In Step S56i, the path restoration unit 52f notifies the storage management server 40 that the paths of all the corresponding cloud volumes 21 have been restored to traverse through the SCSI.

Next, in Step S46i, the path restoration unit 42f of the storage management server 40 receives, from the path switching server 50, the notification that the paths have been restored. Next, in Step S46j, the path restoration unit 42f updates “PATH RESTORATION” of all the corresponding cloud volumes 21 to “COMPLETED” in the path migration threshold table 43a. When Step S46i ends, all the processing processes of the path switching processing (FIG. 5) end.

### Modified Example of Embodiment

### (1) Trigger for Changing Configuration Information Related to Path of Cloud Volume

In the above-mentioned embodiment, the migration of the cloud volume 21 in the volume configuration monitoring unit processing and the access volume information update unit processing (FIG. 7) is used as a trigger to change the configuration information related to the path of the cloud volume 21. However, the trigger is not limited to migration, and the configuration information related to the path of the cloud volume 21 may be changed at other timings as a trigger.

For example, a change in the location of the cloud storage 20 can be used as a trigger. Location changes occur due to changes in cloud vendors or the like. When the location at which the cloud volume 21 is placed is changed, in response to the location change, the storage management server 40 recognizes location information and volume information on the cloud volume 21 and notifies the path switching server 50 of the location information and the volume information. Therefore, in path switching, the path switching server 50 can manage which of the cloud volumes 21 is to be subjected to path switching, and can adapt to location changes of the cloud volume 21.

### (2) Dynamic Determination on “AVAILABILITY OF DIRECT ACCESS TO CLOUD VOLUME”

In the above-mentioned embodiment, “AVAILABILITY OF DIRECT ACCESS TO CLOUD VOLUME” in the volume management table 43b (FIG. 3) is determined in advance by the user and remained fixed once determined. However, the present invention is not limited to this, and “AVAILABILITY OF DIRECT ACCESS TO CLOUD VOLUME” may be dynamically determined or may fluctuate based on determinations made as needed.

For example, the storage management server 40 records such past loads as the IOPS of the cloud volumes 21 in advance and calculates load predictions based on the past loads. The storage management server 40 estimates the cloud volumes 21 whose loads exceed a threshold in a busy period or the like, based on the load predictions. Then, the storage management server 40 proposes, to the user as path switching candidates, the cloud volumes 21 whose loads become equal to or less than the threshold by path switching among the estimated cloud volumes 21. Then, the storage management server 40 may determine “AVAILABILITY OF DIRECT ACCESS TO CLOUD VOLUME” of the cloud volume 21 approved by the user to be “AVAILABLE.”

Furthermore, the storage management server 40 may execute the above-mentioned load predictions, estimation of the cloud volumes 21, proposal of path switching candidates, and determination as to “AVAILABILITY OF DIRECT ACCESS TO CLOUD VOLUME” as needed. With this, for example, even when further path switching is required after path switching but the cloud volume 21 capable of path switching does not exist, the cloud volume 21 capable of path switching can additionally be secured.

### (3) Timing of Path Restoration

In the above-mentioned embodiment, path restoration is executed at a restoration timing defined in advance, such as at the end of a busy period. However, the present invention is not limited to this, and the storage management server 40 and the path switching server 50 may execute path restoration with fulfillment of predetermined conditions as a trigger. For example, when the load state of the IOPS is continuously at, for example, 60% of a threshold for a certain period (for example, one week), the storage management server 40 and the path switching server 50 may carry out path restoration by selecting the cloud volumes 21 within a range that does not exceed the threshold from among the cloud volumes 21 for which path switching has been carried out.

### (4) Timing of Path Switching

In the above-mentioned embodiment, when the IO load of the path P1 from the host 30 to the on-premises storage 10 exceeds the threshold, the path from the host 30 to the cloud volume 21 is switched from the path P1 to the path P2. However, the timing of path switching is not limited to when the IO load of the path P1 exceeds the threshold, and path switching may be triggered by fulfillment of other conditions. For example, path switching may be triggered by user instructions.

### (5) Storage Management Server 40 and Path Switching Server 50

In the above-mentioned embodiment, the storage management server 40 and the path switching server 50 are separate servers. However, the present invention is not limited to this, and the storage management server 40 and the path switching server 50 may be an integrated server. For example, the path switching server 50 may be provided as an add-on for adding functionality to the storage management server 40.

### Effects of Embodiment

In the above-mentioned embodiment, path switching for switching from a first path based on first mapping information to a second path based on second mapping information is executed. Therefore, the IO load related to the on-premises storage 10, to which the cloud storage 20 is externally connected, and the network N1 can be reduced.

Further, in the above-mentioned embodiment, in a switching executable period for path switching, when the IO load of the first path from the host 30 to the on-premises storage 10 exceeds the threshold, path switching is executed from the first path to the second path. Therefore, for example, in a busy period in which the IO load of the first path from the host 30 to the on-premises storage 10 increases, when there is an increase in the IO to the on-premises storage 10, the IO load of the on-premises environment can be reduced.

Further, in the above-mentioned embodiment, when the cloud volume 21 is changed due to a change related to the cloud storage 20, mapping information for mapping to the host 30 via the path P1 and mapping information for mapping to the host 30 via the path P2 are changed. Therefore, it is possible to make the mapping information follow configuration changes of the cloud.

Further, in the above-mentioned embodiment, the change related to the cloud storage 20 is migration from the cloud volume 21 to another cloud volume or a change in connection destination cloud volume. Therefore, it is possible to make the mapping information follow migration of the cloud volume or configuration changes of AWS (registered trademark) availability zones.

Further, in the above-mentioned embodiment, after path switching is executed, data related to the IO from the host 30 to the cloud volume 21 via the path P1 is cached in the on-premises storage 10 and the host 30. Then, the cache data in the on-premises storage 10 is reflected in the cloud volume 21, and the cache data in the host 30 is then reflected in the cloud volume 21. Therefore, in path switching, data related to the IO can completely be reflected in the cloud volume 21.

Further, in the above-mentioned embodiment, the availability of executing path switching is managed for each of the cloud volumes 21, and path switching is executed for the cloud volume 21 for which path switching execution is available. Therefore, path switching can be executed only for the appropriate cloud volume 21 in accordance with user intentions or the like.

Further, in the above-mentioned embodiment, the availability of executing path switching is set to available for the cloud volume 21 with a predicted value for a load related to the IO from the host 30 exceeding a predetermined threshold, and the availability of executing path switching is set to not available for the cloud volume 21 with a predicted value being equal to or less than the predetermined threshold. Therefore, path switching can be executed only for the appropriate cloud volume 21 depending on a predicted value for a load related to the IO.

Further, in the above-mentioned embodiment, a cloud usage fee that is incurred when path switching is executed for the cloud volume 21 for which the availability of executing path switching has been determined to be available is calculated, and path switching is executed for the cloud volume 21 for which the cloud usage fee has been determined to be within an acceptable range. Therefore, path switching can be executed only for the cloud volume 21 for which the user has allowed path switching as he/she has deemed the cloud usage fee appropriate.

Further, in the above-mentioned embodiment, path restoration from the path P2 to the original path P1 is executed when the path migration conditions are no longer satisfied. For example, path restoration is executed based on a situation where a switching executable period for path switching has ended, or a situation where the load related to the IO to the cloud volume 21 has become equal to or less than a threshold. Therefore, an unlimited increase in the usage fee of the cloud storage 20 can be prevented.

Further, in the above-mentioned embodiment, after path restoration is executed, data related to the IO from the host 30 to the cloud volume 21 via the path P2 is cached in the host 30, and the cache data is reflected in the cloud volume 21. Therefore, in path restoration, data related to the IO can completely be reflected in the cloud volume 21.

The present invention is not limited to the above-mentioned embodiment and includes various modified examples. Further, the above-mentioned embodiment has been described in detail to clearly describe the present invention, and the present invention is not necessarily limited to including all the described components. In addition, not only the deletion of such components but also the replacement or addition of components is possible. Further, modes that appropriately combine part or all of the components of the above-mentioned embodiment in a consistent manner are also included in the embodiment of the present invention.

Further, each of the above-mentioned components, functions, processing units, processing means, and the like may be achieved in hardware by designing them by integrated circuits, for example, in part or in whole. Further, the present invention can also be achieved by program codes of software configured to achieve the functions of the embodiment. In this case, a recording medium having stored therein the program codes is provided to a computer, and a processor of that computer reads the program codes stored in the recording medium.

In this case, the program codes read from the recording medium themselves achieve the functions of the embodiment described above, and the program codes themselves and the recording medium having stored therein the program codes form the present invention. As the recording medium for supplying such program codes, for example, a flexible disk, a CD-ROM, a DVD-ROM, a hard disk, an SSD, an optical disc, a magneto-optical disk, a CD-R, a magnetic tape, a non-volatile memory card, or a ROM is used.

Furthermore, the program codes for achieving the functions described in the present embodiment can be implemented in, for example, a wide range of programming or scripting languages such as assembler, C/C++, perl, Shell, PHP, or Java (registered trademark).

In the above-mentioned embodiment, the control lines and information lines considered to be necessary for description are described, and all the control lines and information lines in products are not necessarily described. All the components may be connected to each other.

What is claimed is:

1. A storage system comprising:
a first storage on-premises;
a second storage on a cloud;
a host; and
a server configured to manage the host, the first storage, and the second storage via a second network,
wherein
the first storage is connected to the host via a first network for input/output from the host and provides a plurality of volumes including a first volume to the host,
the second storage is connected to the host via a first path that traverses through the first network and the first storage for the input/output from the host, and provides a second volume to the host, and
the server is configured to
manage first mapping information for mapping the second volume to the host via the first path and second mapping information for mapping the second volume to the host via a second path that traverses through the second network, and
execute path switching from the first path based on the first mapping information to the second path based on the second mapping information when a predetermined condition is satisfied.

2. The storage system according to claim 1, wherein
the server is configured to
manage a threshold for a load of input/output from the host to the first storage and a switching executable period for the path switching,
monitor whether the load of the input/output from the host to the first storage exceeds the threshold, and
execute the path switching by regarding a case where the load of the input/output exceeds the threshold in the switching executable period as a case where the predetermined condition is satisfied.

3. The storage system according to claim 1, wherein
the server is configured to, when the second volume is changed to a third volume due to a configuration change related to the second storage,
update the first mapping information to third mapping information for mapping the third volume to the host via the first path,
update the second mapping information to fourth mapping information for mapping the third volume to the host via the second path, and
execute path switching from the first path based on the third mapping information to the second path based on the fourth mapping information when the predetermined condition is satisfied.

4. The storage system according to claim 3, wherein
the configuration change related to the second storage is either migration from the second volume to the third volume or a volume change.

5. The storage system according to claim 1, wherein
the server is configured to
cache, after executing the path switching, data related to input/output from the host to the second volume via the first path in the first storage and the host, and
reflect the data cached in the first storage in the second volume and then reflect the data cached in the host in the second volume.

6. The storage system according to claim 2, wherein
the second storage provides a plurality of the second volumes to the host, and
the server is configured to
manage availability of executing the path switching for each of the second volumes, and
execute the path switching for the second volume for which the availability of executing the path switching has been determined to be available.

7. The storage system according to claim 6, wherein
the server is configured to
predict, based on a load of input/output from the host to each of the second volumes via the first path in past, the load of the input/output in the switching executable period in future for each of the second volumes,
set the availability of executing the path switching to available for the second volume with a predicted value for the load of the input/output exceeding a predetermined threshold, and
set the availability of executing the path switching to not available for the second volume with a predicted value for the load of the input/output being equal to or less than the predetermined threshold.

8. The storage system according to claim 6, wherein
the server is configured to
calculate a fee related to the cloud that is incurred when the path switching is executed for the second volume for which the availability of executing the path switching has been determined to be available, and
execute the path switching for the second volume for which the fee calculated has been determined to be within an acceptable range.

9. The storage system according to claim 1, wherein
the server is configured to execute path restoration from the second path related to the second mapping information to the first path related to the first mapping information when the predetermined condition is no longer satisfied.

10. The storage system according to claim 2, wherein
the server is configured to execute path restoration from the second path related to the second mapping information to the first path related to the first mapping information based on a situation where the switching executable period has ended or a situation where the load has become equal to or less than the threshold.

11. The storage system according to claim 9, wherein
the server is configured to
cache, after executing the path restoration, data related to input/output from the host to the second volume via the second path in the host, and
reflect the data cached in the host in the second volume.

12. A volume path switching method for a storage system to be executed by a storage system,
the storage system including
a first storage on-premises,
a second storage on a cloud,
a host, and
a server configured to manage the host, the first storage, and the second storage via a second network,
the first storage being connected to the host via a first network for input/output from the host and providing a plurality of volumes including a first volume to the host,
the second storage being connected to the host via a first path that traverses through the first network and the first storage for the input/output from the host, and providing a second volume to the host,
the volume path switching method comprising:
managing, by the server, first mapping information for mapping the second volume to the host via the first path and second mapping information for mapping the second volume to the host via a second path that traverses through the second network; and
executing, by the server, path switching from the first path based on the first mapping information to the second path based on the second mapping information when a predetermined condition is satisfied.
